(19) United States
(12) Patent Application Publication
(10) Pub. No.: US 2005/0082071 A1
(43) Pub. Date: Apr. 21, 2005

(54) Electrical grounding rod driver

(76) Inventor: Dwayne Saxon, Franklin, TX (US)

Correspondence Address: National IP Rights Center, LLC;Suite 400, 550 Township Line Road, Blue Bell, PA, 19422, US

(21) Appl. No.: 10/690,209

(22) Filed: Oct. 21, 2003

(51) Int. Cl. B25D 9/00

(52) U.S. Cl. 173/90

(57) ABSTRACT

A novel grounding rod driver comprising: a conically shaped member having a distal opening at its narrow end and axially extending channel through its center so as to facilitate attachment to the striking end of a grounding rod; a disk shaped anvil member affixed to the proximal wide end of the conical member for facilitating the driving of the grounding rod; a pivotable handle affixed to the conical shaped member to hold and support the driver.

### FIELD OF THE INVENTION

The present invention is directed to the field of ground rods. In particular, the present invention is directed to the field of grounding rod drivers.

### BACKGROUND OF THE INVENTION

Electrical grounding rods are required to insure that line electrical apparatus, for example, electrical power transmission systems and the sub-stations connected therewith as well as telephone lines, are kept at earth potential. Steel structures such as oil well derricks and windmills should be grounded as a precautionary measure against lightning strikes. Lightning arrester systems to protect structures extending well above ground level must be grounded. In the past, grounding rods have been of various lengths and have been hollow or solid and generally have terminated with a short portion of the grounding rod projecting above ground. Hollow rods were driven into the ground using a point of a hard metal to which one end of the rod was attached or on which the hollow end rested. A wooden rod was inserted into the hollow grounding rod into contact with the point.

In some instances the other end of the wooden driving rod was struck with a hammer-like device. In other instances the other end of the wooden driving rod has a weight attached thereto, and the rod was moved up and down inside the hollow grounding rod. (see U.S. Pat. Nos. 1,147,791; 1,962,758; 2,145,420 and 2,147,828). To use these devices it was necessary for the operator to stand on some object which would enable him to bring the necessary force onto the top of the device (see 21147.828).

An improvement over these devices is disclosed in U.S. Pat. No. 4,335,622 wherein a soil gas sampling probe is driven into the soil by means of a collar which is secured to the probe as an anvil and a cylindrical mass is slipped over the probe and strikes the anvil as a hammer by raising it up and bringing it down into contact with the anvil. This device will permit driving the probe into the ground until only that length represented by the depth of the collar and length of the hammer is left above ground level.

The National Electrical Code has established that grounding rods shall be 8 feet in length, generally of solid stock and shall be driven into the ground so that the top of the rod is about 12 inches below ground level. The first above-described devices can meet this requirement but are difficult to initiate the driving. The last above-described device eases the task of driving the rod into the ground but must be removed and a hammer used to drive the remaining length of the rod below the ground level or a deeper hole must be initially dug.

The patent literature has disclosed several systems directed to driving grounding rods. U.S. Pat. No. 6,364,031 to Amicangelo is directed to a rod driving and extracting tool having a head connected to a handle provided. The tool has two ends, each of which has an open bore, or rod-receiving end for communicating a section of a rod to be driven through either a first or second hollow handle section, respectively. The first and second hollow handle sections each have a second end forming a rod-driving surface disposed in the handle. The first and second rod driving surfaces are on opposite sides of a generally solid, rod driving section interposed between the first and second hollow handle sections. The head has at least one additional driving surface in the form of a striking face. A rod extraction tool in the form of a cross-wise hole through the handle is provided in the solid rod driving section. Methods of using the tool to install a rod or to extract a partially exposed rod, are provided.

U.S. Pat. No. 5,188,187 to Mumper is directed to an electrical grounding rod driving tool for use with an externally powered hammer comprising a shaft portion for insertion into a tool receiving chuck of the hammer and a base portion extending outwardly from said shaft portion which receives and retains the end of a grounding rod to which the powered hammer is applied. The base portion comprising an inwardly extending elongated tapering bore from the exterior end of said base portion which bore is identified as a conical bore, the outer circumference of which is in tangential relationship with the walls of said inwardly extending conical bore. The diameter of said bore at said exterior is greater than the original exterior diameter of the rod to be driven, the diameter of said bore at the truncated terminus being less than the original diameter of said rod. The bore in the base portion having an inwardly extending length of approximately one-half the length of the base portion of the tool.

U.S. Pat. No. 5,864,093 to Heckock is directed to an electrical ground connector assembly for providing a fast, secure, moisture-resistant ground connection without using special tools. The electrical ground connector assembly includes a ground rod and a cap having an tapered rod chamber for the ground rod. The cap also includes at least one wire hole adjacent the tapered rod chamber at the bottom of the cap for receiving a ground wire. The wire hold is preferably at an angle of approximately six degrees with respect to the tapered rod chamber and merges with or intersects the rod chamber. In installation, the ground wire is inserted into the wire hole through the bottom of the cap. The upper end of the ground rod is forced into the rod cavity of the cap by any suitable manner, such as hammering the cap down over the ground rod. As the upper end of the ground rod reaches the end of the rod cavity and the ground wire extending into the cavity, it contacts and wedges itself into mechanical and electrical contact therewith. Alternatively, the ground rod can first be driven into the ground, and then the ground wire and the cap can be assembled on the ground rod.

Finally, U.S. Pat. No. 4,557,409 is directed to a double-headed hammer slidingly encompassing a ground rod-driving shaft having a single anvil affixed thereto which can be selectively engaged by either hammer. The driving shaft has a recess in each end to receive the grounding rod, depending upon whether the action is to initiate and continue the insertion of the grounding rod into the ground or to complete the insertion of the rod in accordance with the provisions of the Code. The present invention does not require the operator to take a position above the ground or to use any other instrument to make the complete and proper insertion of the grounding rod into the ground.

Most of the prior art systems comprise ad hoc mechanisms which are not uniquely tailored to ground rod driving or which utilize or rely upon multi-piece apparatus.

It would be desirable to provide a grounding rod driver which can easily be used by a installed and used by a single person without complicated or multipiece mechanical apparatus,

It is therefore the principal object of the present invention to provide a ground rod driver which can be used by a single person without the need for complicated power apparatus.

### SUMMARY OF THE INVENTION

In accordance with the present invention, a novel grounding rod driver comprising is disclosed. The invention comprises a conically shaped member having a distal opening at its narrow end and axially extending channel through its center so as to facilitate attachment to the striking end of a grounding rod; an anvil member affixed to the proximal wide end of the conical member for facilitating the driving of the grounding rod; and a handle affixed to the conical shaped member to hold and support the driver. The drounding rod driver may be constructed from a range of material including steel, copper, aluminum and titanium.

In a further embodiment, the novel grounding rod driver comprises conically shaped member having a distal opening at its narrow end and axially extending channel through its center so as to facilitate attachment to the striking end of a grounding rod; a disk shaped anvil member affixed to the proximal wide end of the conical member for facilitating the driving of the grounding rod; a pivotable handle affixed to the conical shaped member to hold and support the driver.

### DESCRIPTION OF THE FIGURES

FIG. 1 s an isolated side view of the ground rod driver of the present invention.

FIG. 2 is a underside view of the ground rod driver of the present invention.

FIG. 3 is a plan view of the ground rod driver of the present invention.

FIG. 4 is an enlarged side view of the rod driver of the present invention highlighting the handle.

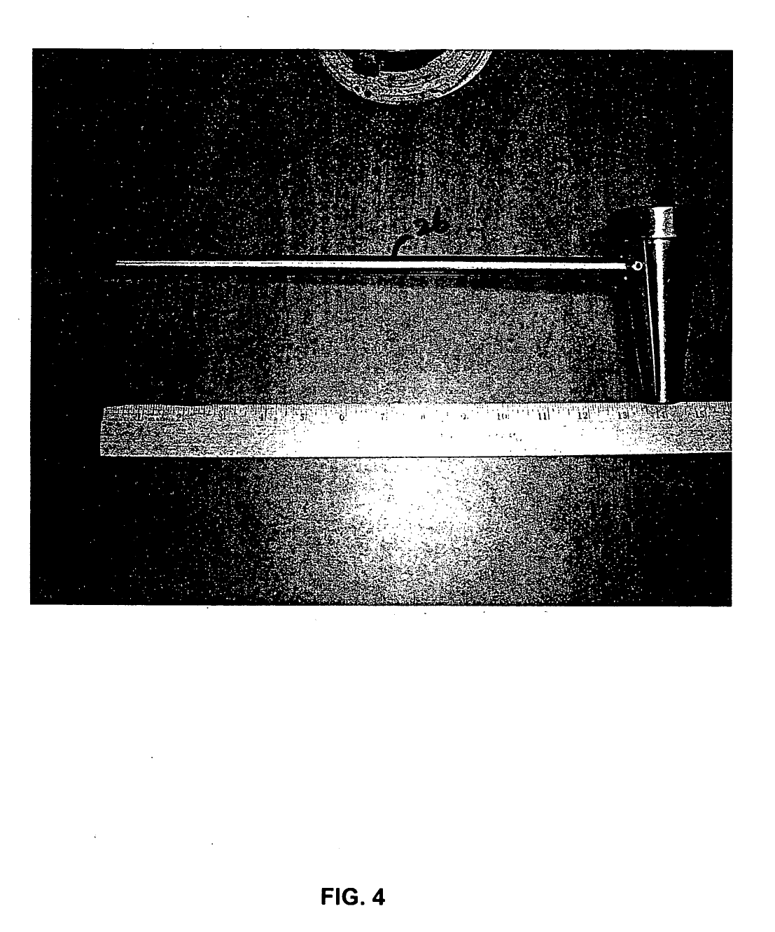

### DETAILED DESCRIPTION OF THE INVENTION

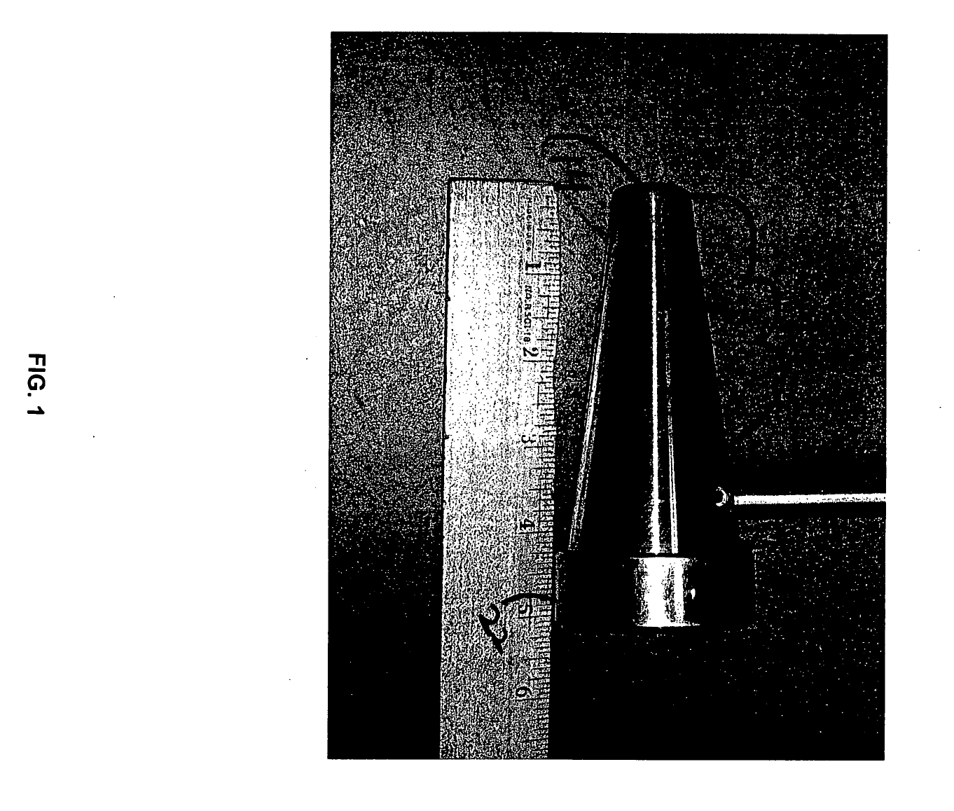

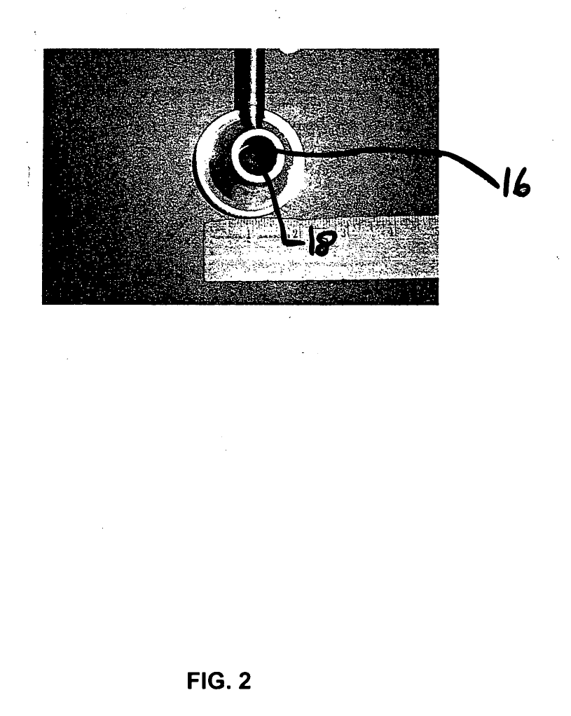

The present invention is described with reference to the enclosed Figures when the same numbers utilized were applicable. Referring to FIGS. 1 to 3, the electric grounding rod driving mechanism 10 the present invention is shown. The device comprises a substantially conical member 12 having a conically pointed distal surface 14. The distal end 14 of the member 12 has an aperture 16 and a cylindrical channel 18 extending axially into the middle of the conical member 12. This channel 18 is designed to overlays and envelopes the striking end of the grounding rod to be driven into the ground.

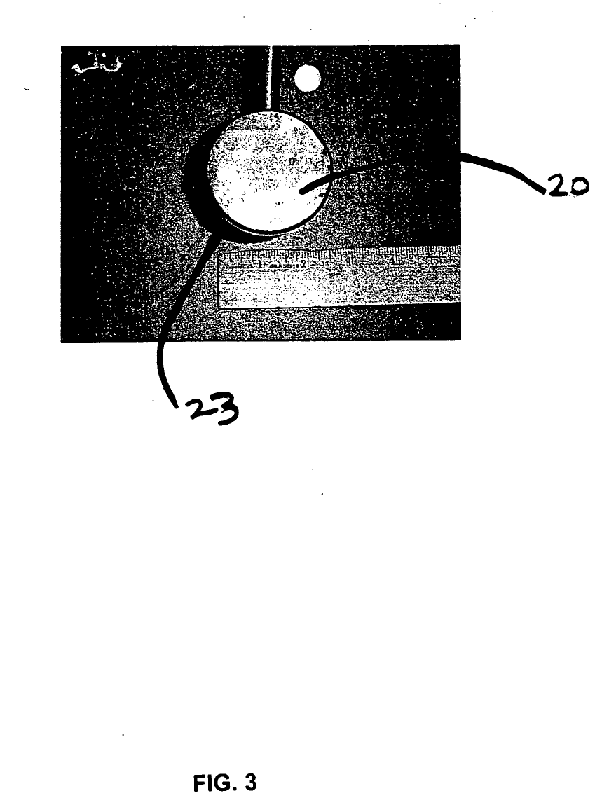

Referring to FIGS. 1 and 3, an anvil member 20 is affixed to the proximal end 22 of the conically shaped member 12. In one embodiment, this anvil may be cylindrical or disc-shaped anvil 23. As shown in FIG. 3, the anvil has a striking surface 24. A handle 26 is affixed to the cylindrical member and may be pivotable (See arrows). The handle permits the grounding rod driver to be support by a workman while in use.

To install a grounding rod using the present invention, an initial hole, perhaps eight to ten inches, is prepared. The aperture 16 placed over the non-pointed end of the eight-foot grounding rod, which extends into the channel 18 and the pointed end of the grounding rod is placed in the bottom of the hole. This leaves about seven feet of the grounding rod plus the length of the invention above ground, well within the reach of the average operator. The operator holding the extension handle 26 can then drive the grounding rod into the ground using a hammer such that the cylindrical heading pushes downward into the ground itself so that the grounding rod is the required distance below ground.

The present invention has been described with reference to the enclosed figures. It is to be appreciated that other embodiments fulfill the spirit and scope of the present invention and that the true nature and scope of the present invention is to be determined with reference to the claims attached hereto.

1. A novel grounding rod driver comprising:
a conically shaped member having a distal opening at its narrow end and axially extending channel through its center so as to facilitate attachment to the striking end of a grounding rod;
an anvil member affixed to the proximal wide end of the conical member for facilitating the driving of the grounding rod;
a handle affixed to the conical shaped member to hold and support the driver.

2. The novel grounding rod driver of claim 1 where in said grounding rod driver is constructed form steel.

3. The novel grounding rod driver of claim 1 wherein said grounding rod driver is constructed from titanium.

4. A novel grounding rod driver comprising:
a conically shaped member having a distal opening at its narrow end and axially extending channel through its center so as to facilitate attachment to the striking end of a grounding rod;
a disk shaped anvil member affixed to the proximal wide end of the conical member for facilitating the driving of the grounding rod;
a pivotable handle affixed to the conical shaped member to hold and support the driver.
